(19) United States
(12) Patent Application Publication
(10) Pub. No.: US 2015/0245401 A1
(43) Pub. Date: Aug. 27, 2015

(54) METHODS AND APPARATUS FOR CONVERTING A SINGLE RADIO-ACCESS TECHNOLOGY CONNECTION INTO A MULTIPLE RADIO-ACCESS TECHNOLOGY CONNECTION

(71) Applicant: Google Technology Holdings LLC, Mountain View, CA (US)

(72) Inventor: Apostolis Salkintzis, Athens (GR)

(21) Appl. No.: 14/330,276

(22) Filed: Jul. 14, 2014

Related U.S. Application Data
(60) Provisional application No. 61/944,723, filed on Feb. 26, 2014.

(51) Int. Cl. H04W 76/02

(52) U.S. Cl. CPC H04W 76/025

(57) ABSTRACT

A method for converting a single radio-access technology (“RAT”) packet-data network (“PDN”) connection into a multi-RAT PDN connection includes establishing a PDN connection having a first radio bearer using a first RAT, adding, using a second RAT, a second radio bearer for the PDN connection, and transmitting data packets over the PDN connection using both the first radio bearer and the second radio bearer. In some implementations, adding the second radio bearer includes generating a first traffic-flow template (“TFT”) for the first radio bearer, generating a second TFT for the second radio bearer, transmitting data packets over the first radio bearer according to the first TFT, and transmitting data packets over the second radio bearer according to the second TFT.

### CROSS-REFERENCE TO RELATED APPLICATIONS

The present application claims priority to U.S. Provisional Patent Application 61/944,723, filed Feb. 26, 2014, the contents of which are incorporated herein by reference.

### TECHNICAL FIELD

The present disclosure relates generally to wireless network communication and, more particularly, to communicating over a packet-data connection using multiple radio-access technologies.

### BACKGROUND

One of the most popular uses for wireless devices is accessing packet-data networks (“PDNs”), the most famous example of which is the Internet. In Third Generation Partnership Project (“3GPP”) networks, a user equipment (“UE”) can have one or more simultaneous PDN connections. Each PDN connection is an Internet protocol (“IP”) interface with one or two IP addresses. A PDN connection constitutes a point-to-point layer-2 tunnel that extends between the UE and a packet gateway (“PGW”) that generally resides at the edge of the 3GPP network (e.g., the VERIZON® network or AT&T® network) and is typically associated with an access point name (“APN”) of an access point.

A UE can establish a PDN connection using different types of radio-access technologies (“RATs”). Examples of RATs include 3GPP RATs, such as Long-Term Evolution (“LTE”), and wireless local area network (“WLAN”) RATs, such as the Institute for Electrical and Electronics Engineers (“IEEE”) 802.11 family of standards. Currently, each PDN connection on a 3GPP network uses a single RAT at any given time.

### BRIEF DESCRIPTION OF THE SEVERAL VIEWS OF THE DRAWINGS

While the appended claims set forth the features of the present techniques with particularity, these techniques may be best understood from the following detailed description taken in conjunction with the accompanying drawings of which:

FIG. 1 is a block diagram of a communication system;

FIG. 2 is a block diagram of a representative UE;

FIG. 3 through FIG. 7 are block diagrams of a UE in communication with a PGW; and

FIG. 8 and FIG. 9 are flowcharts depicting methods for communicating over multiple RATs.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

The present disclosure describes methods and an apparatus for converting a single-RAT PDN connection into a multi-RAT PDN connection. According to various embodiments, a method includes establishing a PDN connection having a first radio bearer using a first RAT, adding (using a second RAT) a second radio bearer for the PDN connection, and transmitting data packets over the PDN connection using both the first radio bearer and the second radio bearer. In some embodiments, adding the second radio bearer includes generating a first traffic-flow template (“TFT”) for the first radio bearer, generating a second TFT for the second radio bearer, transmitting data packets over the first radio bearer according to the first TFT, and transmitting the data packets over the second radio bearer according to the second TFT.

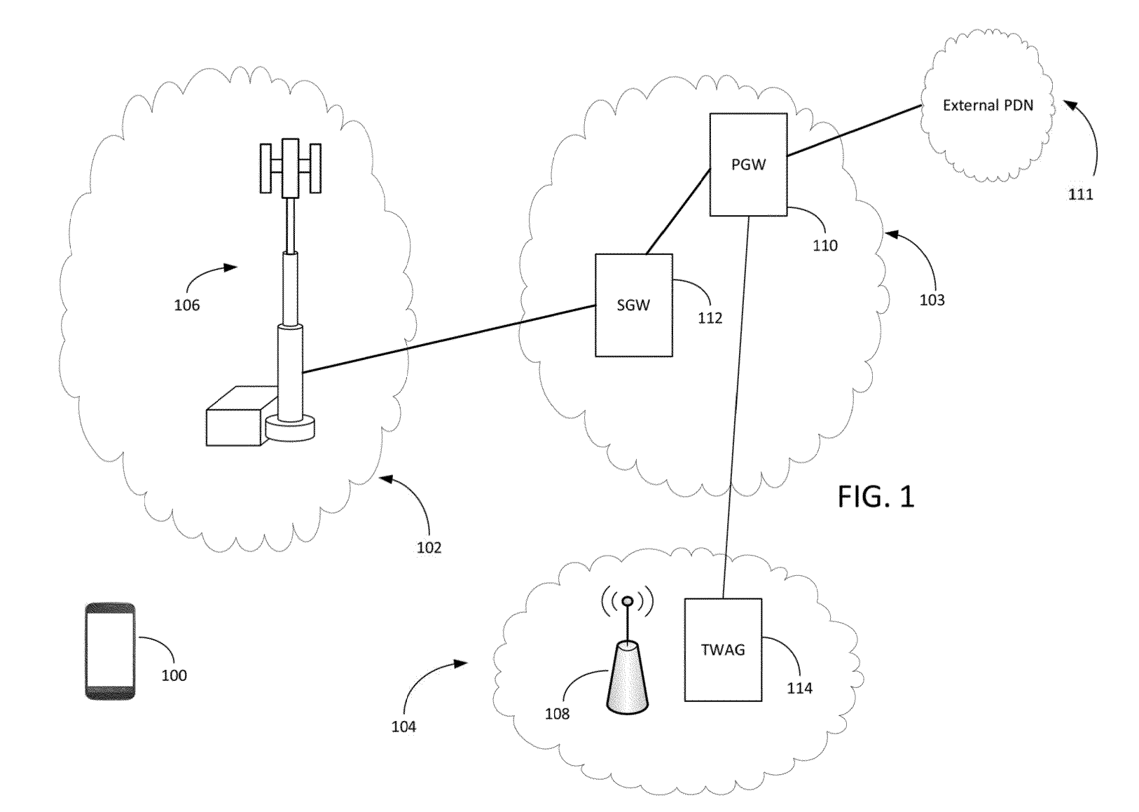

Turning to FIG. 1, in an embodiment, a UE 100 is configured to communicate over a first radio-access network (“RAN”) 102 and over a second RAN 104. The first RAN 102 includes a base station 106. The base station 106 is one of many base stations of first RAN 102. The base station 106 is connected to other parts of the first RAN 102 by one or more well known mechanisms. Possible implementations of the base station 106 include an enhanced Node B. The UE 100 communicates over the first RAN 102 by way of the base station 106 using a first RAT. The second RAN 104 includes a wireless access point (“AP”) 108. The UE 100 communicates over the second RAN 104 by way of the AP 108 using a second RAT. Possible implementations of the first RAT include a 3GPP technology, such as LTE or other cellular communication technology. Possible implementations of the second RAT include a WLAN RAT, such as one of the IEEE 802.11 family of communication technologies. Possible implementations of the UE 100 include a cellphone (e.g., a smartphone), a tablet computer, a notebook computer, and a wearable device (e.g., a smartwatch).

The first RAN 102 interfaces with a core network 103. The core network 103 includes a PGW 110. The PGW 110 provides the UE 100 with connectivity to external PDNs and serves as the point of exit and entry of data-packet traffic for the UE 100. The UE 100 may be connected to more than one PGW at the same some in order to access multiple PDNs. The PGW 110 carries out policy enforcement, packet filtering, and other functions. The PGW 110 also acts as the mobility anchor for the user plane of the first RAN 102 during handovers between the base stations of the first RAN 102. The PGW 110 is communicatively linked to one or more external PDNs (e.g., the Internet), represented by the external PDN 111. The core network 103 also includes a serving gateway (“SGW”) 112. The SGW 112 routes and forwards data packets (e.g., IP data packets) to and from the UE 100 via the first RAN 102.

The second RAN 104 further includes a trusted wireless access gateway (“TWAG”) 114. The RAN 104 is considered “trusted” by the core network 103 and uses the TWAG 114 to allow the UE 100 to gain access to the core network 103 by way of the AP 108. In some embodiments, the TWAG 114 is replaced by an evolved packet-data gateway (“ePDG”).

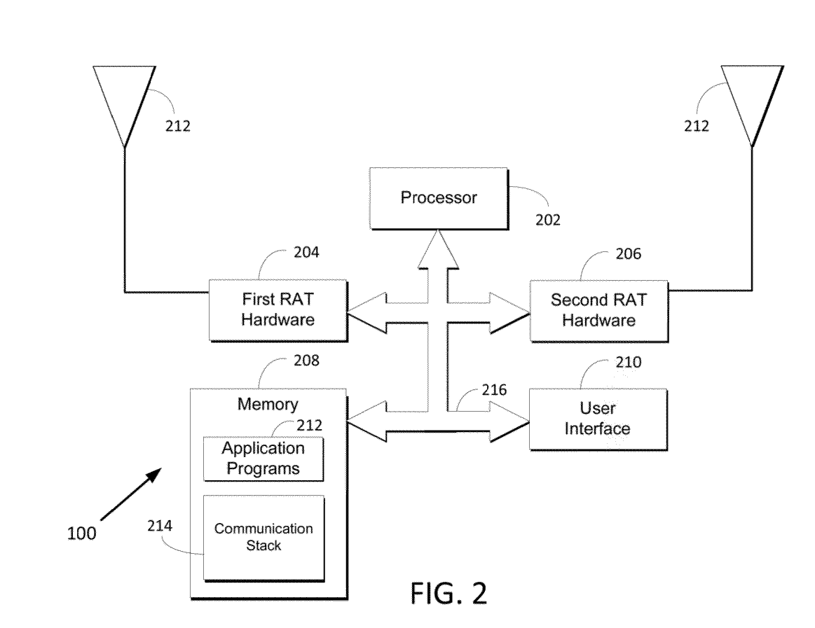

Turning to FIG. 2, a possible implementation of the UE 100 includes a processor 202, first RAT hardware 204 (e.g., a baseband chipset capable of communicating by radio according to a 3GPP standard), and second RAT hardware 206 (e.g., a WLAN chipset capable of communicating by radio according to one or more of the IEEE 802.11 family of standards). The UE 100 further includes memory 208, a user interface 210 (e.g., a touchscreen), and antennas 212. The memory 208 can be implemented as volatile memory, non-volatile memory, or a combination thereof. The memory 208 may be implemented in multiple physical locations and across multiple types of media (e.g., dynamic random-access memory plus a hard-disk drive). The processor 202 retrieves instructions from the memory 208 and operates according to those instructions to carry out various functions, including providing outgoing data to and receive incoming data from the first RAT hardware 204 and the second RAT hardware 206. Among the possible instructions that the processor 202 carries include those of various application programs 212 and those of a communication stack 214 (e.g., a transport control protocol (“TCP”) and IP stack).

Each of the elements of the UE 100 is communicatively linked to the other elements via data pathways 216. Possible implementations of the data pathways 216 include wires, conductive pathways on a microchip, and wireless connections. Possible implementations of the processor 202 include a microprocessor, a microcontroller, and a digital signal processor.

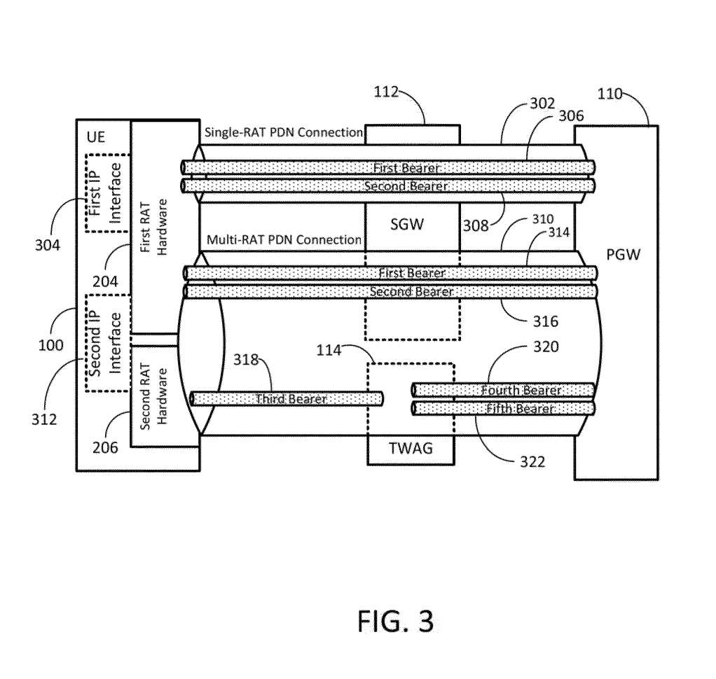

Turning to FIG. 3, the UE 100 uses the first RAT hardware 204 to establish a single-RAT PDN connection 302. The single-RAT PDN connection 302 terminates at the PGW 110 via the SGW 112 and is associated with a first IP interface 304 in the UE 100. The single-RAT PDN connection 302 has a first bearer 306 and a second bearer 308. In an embodiment, the UE 100 establishes the single-RAT PDN connection 302 according to procedures set forth by 3GPP. Using both the first RAT hardware 204 and the second RAT hardware 206, the UE 100 establishes a multi-RAT PDN connection 310 associated with a second IP interface 312 in the UE 100. The multi-RAT PDN connection 310 includes a first bearer 314 and a second bearer 316, which the UE 100 supports with the first RAT hardware 204, as well as a third bearer 318, which the UE 100 supports with the second RAT hardware 206. The UE 100 establishes the first bearer 314 and the second bearer 316 of the multi-RAT PDN connection 310 via the SGW 112. In an embodiment, the first bearer 314 and the second bearer 316 of the multi-RAT PDN connection 310 are evolved packet system (“EPS”) bearers. As used herein, “EPS bearer” refers to a point-to-point logical link within a single PDN connection that has specific quality-of-service (“QoS”) characteristics. Typically, different EPS bearers are used to carry traffic with different QoS requirements. For example, one EPS bearer may be used in a PDN connection to carry voice-over-IP traffic, while another EPS bearer may be used in the same PDN connection to carry web-browsing traffic. In some embodiments, an EPS bearer is a concatenation of individual bearers: an EPS radio bearer (from the UE 100 to the base station 106), a 3GPP S1 bearer (from the base station 106 to the SGW 112), and a general packet radio service tunneling protocol (“GTP”) bearer (from the SGW 112 to the PGW 110).

The UE 100 establishes the third bearer 318 of the multi-RAT PDN connection 310 via the TWAG 114. The third bearer 318 is a WLAN radio bearer which the UE 100 establishes between itself and the TWAG 114. The third bearer 318 may be associated with one or more bearers between the TWAG 114 and the PGW 110, e.g., with a fourth bearer 320 and a fifth bearer 322 shown in FIG. 3. The fourth bearer 320 and the fifth bearer 322 may be either GTP bearers or proxy mobile IP version 6 (“PMIPv6”) bearers established with procedures specified in 3GPP technical specification (“TS”) 23.402. Data packets transferred from the UE 100 to the TWAG 114 via the third bearer 318 are forwarded either to the fourth bearer 320 or to the fifth bearer 322 based on, for example, their QoS requirements. For example, voice-over-IP packets may be forwarded to the fourth bearer 320, while all other packets are forwarded to the fifth bearer 322. The TWAG 114 performs this forwarding based on one or more pre-installed TFTs. Each TFT includes a list of packet filters (e.g., IP packet filters). Typically, the “default” bearer does not have a TFT. The UE 100 compares every outgoing packet with the TFTs of each radio bearer. If there is a match, then the UE 100 transmits the packet to the associated radio bearer. If there is no match, then the UE 100 sends the packet to the default radio bearer. In some embodiments, however, there is only one GTP or PMIPv6 bearer between the TWAG 114 and the PGW 110, and the TWAG 114 does not need a TFT. Because all of the bearers of the multi-RAT PDN connection 310 belong to the same PDN connection, they all share the same IP address, and they are all point-to-point links under the same IP interface. Some of these bearers use the first RAT hardware 204, and some of these bearers use the second RAT hardware 206. Traffic can be transferred among the individual bearers of a multi-RAT PDN connection (and therefore between different RATs) by using the bearer-modification procedures specified by 3GPP.

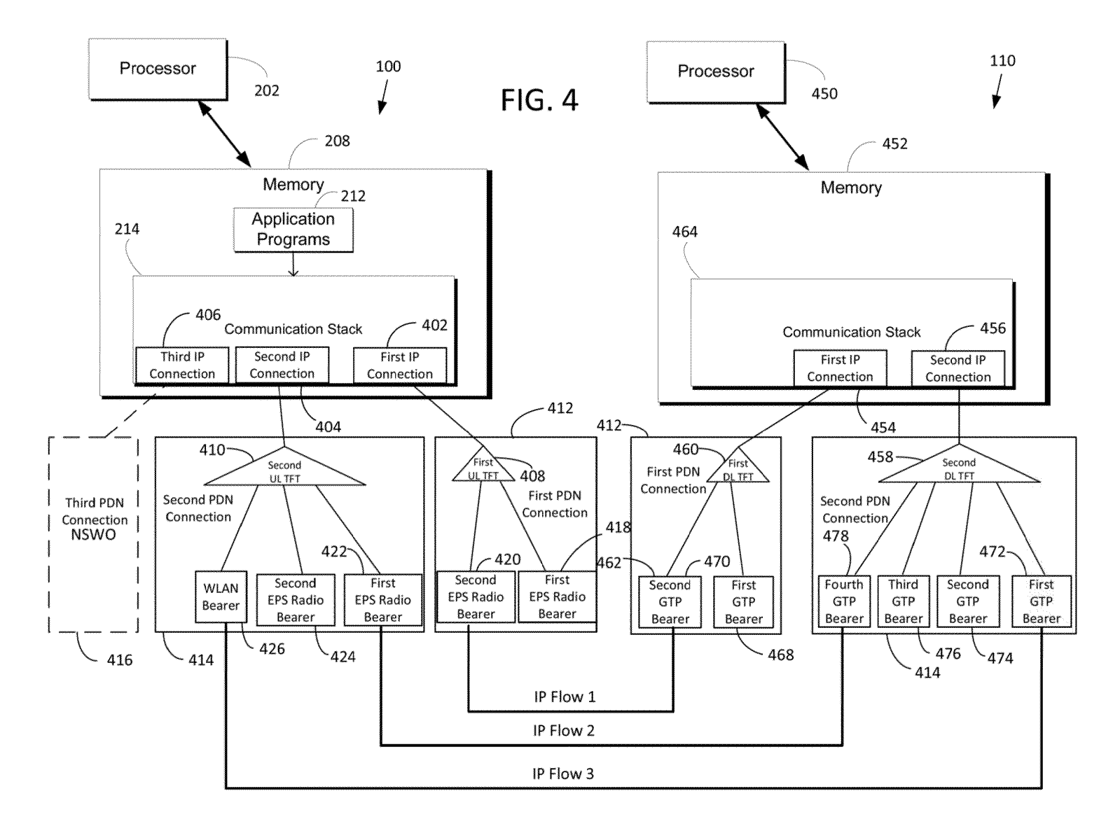

Turning to FIG. 4, in an embodiment, the UE 100 has a first uplink (“UL”) TFT 408 and a second UL TFT 410 resident in its memory 208. Each UL TFT includes one or more packet filters that identify which traffic should be routed inside each bearer (in the uplink direction) with which the UL TFT is associated.

In this embodiment, the PGW 110 includes a processor 450 and a memory 452, whose possible implementations include those described above for the processor 202 and the memory 208 of the UE 100. Like that of the UE 100, the processor 450 of the PGW 110 executes a communication stack 464, which resides in the memory 452. Possible implementations of the memory 452 include those described for the memory 208 of the UE 100. The PGW 110 has a first downlink (“DL”) TFT 460 and a second DL TFT 458 resident in the memory 452. Each DL TFT includes one or more packet filters that identify which traffic should be routed inside each one of the bearers (in the downlink direction) with which the DL TFT is associated.

In the embodiment depicted in FIG. 4, the processor 202 of the UE 100 executes instructions of the communication stack 214 to establish two IP connections: a first IP connection 402 and a second IP connection 404. The UE 100 also executes the instructions of the communication stack 214 to establish a first PDN connection 412 with the PGW 110 and a second PDN connection 414 with the PGW 110. On UE 100's side, the bearers for the first PDN connection 412 include a first EPS radio bearer 418 and a second EPS radio bearer 420, while the bearers for the second PDN connection 414 include a first EPS radio bearer 422, a second EPS radio bearer 424, and a WLAN bearer 426. Therefore, the first PDN connection 412 is a single-RAT PDN connection (i.e., all of its individual bearers use the same RAT), while the second PDN connection 414 is a multi-RAT PDN connection (i.e., at least two of the bearers use different RATs—e.g., a first RAT and a second RAT). On the PGW 110's side, the bearers for the first PDN connection 412 include a first GTP bearer 468 and a second GTP bearer 470, while the bearers for the second PDN connection 414 include a first GTP bearer 472, a second GTP bearer 474, a third GTP bearer 476, and a fourth GTP bearer 478. According to another embodiment, the GTP bearers of FIG. 4 are replaced with PMIPv6 bearers. In some embodiments, the UE 100 also has a direct offload connection 416 to the WLAN, also referred to as a non-seamless WLAN offload (“NSWO”) connection 416, which is associated with a third IP connection 406.

In an embodiment, one of the bearers of the first PDN connection 412 (e.g., the first EPS radio bearer 418) is the default bearer for that connection, meaning that the processor 208 forwards all traffic that does not meet any TFT-filter criteria and is not associated with a TFT. Likewise, one of the bearers of the second PDN connection 414 (e.g., the first EPS bearer 422) is the default bearer for that connection and is not associated with a TFT. Each non-default (or dedicated) bearer is associated with a TFT that includes one or more packet filters.

One advantage of supporting multi-RAT PDN connections (such as the second PDN connection 414) is that it facilitates IP-flow mobility between a first RAT (e.g., a 3GPP RAT) and a second RAT (e.g., a WLAN RAT). More specifically, the UE 100 and the PGW 110 need only change one or both of the TFT filters in order to transfer one or more IP flows from a bearer over WLAN to a bearer over 3GPP access (or vice versa). For example, the UE 100 of FIG. 4 has established IP Flow 1 and IP Flow 2 over a first RAT (e.g., a 3GPP RAT), and IP Flow 3 over a second RAT (e.g., a WLAN RAT). The UE 100 can easily transfer IP flow 2 (e.g., transported over an EPS bearer inside the second PDN connection 414) to the second RAT (e.g., WLAN access) by modifying the packet filters of its second UL TFT 410 and transmitting a message to the PGW 110 requesting that the PGW 110 modify the filters of its second DL TFT 458. Alternatively, the PGW 110 can easily transfer IP flow 2 to the second RAT by modifying the filters of its second DL TFT 458 and transmitting a message to the UE 100 requesting that the UE 100 modify the filters of its second DL TFT 410.

Note that, according to various embodiments, IP-flow mobility can be carried out without any mobility protocol in the UE 100 or in the PGW 110. For example, carrying out IP mobility does not require a dual-stack mobile-IP protocol or the equivalent. This makes IP-flow mobility relatively simple and efficient.

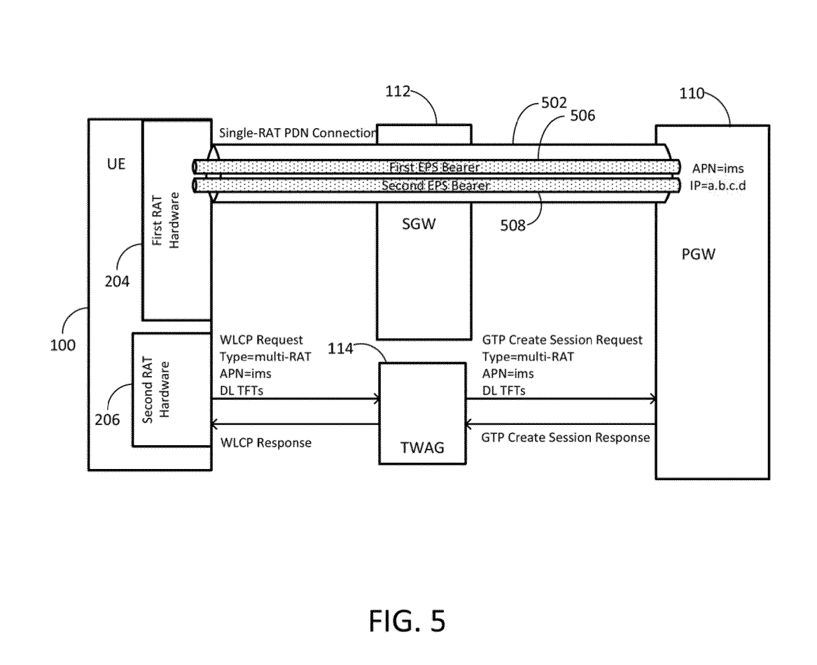

In an embodiment, the UE 100 and the PGW 110 are configured to transfer IP flows among RATs within a multi-RAT PDN connection. Turning to FIG. 5, the UE 100 and the PGW 110 use a well known session set-up procedure to establish a single-RAT PDN connection 502. For the sake of illustration, assume that the RAT used to set up the single-RAT PDN connection 502 (the “first RAT”) is a 3GPP RAT. The first RAT could be a WLAN RAT or other RAT in other scenarios, however. The single-RAT PDN connection 502 has a first EPS bearer 506 and a second EPS bearer 508.

The UE 100 then begins the procedure to turn the single-RAT PDN connection 502 into a multi-RAT PDN connection (e.g., a PDN connection with an additional WLAN bearer). In one scenario, the UE 100 makes this decision. For example, the UE 100 may decide to convert the single-RAT PDN connection 502 to a multi-RAT PDN connection when the UE 100 is provisioned with routing rules, such as IP-flow mobility (“IFOM”) rules, or when a provisioned routing rule becomes valid and relates to the APN of an established PDN connection. The routing rules can be provisioned in the UE from the access network discovery and selection function as specified in 3GPP TS 23.402.

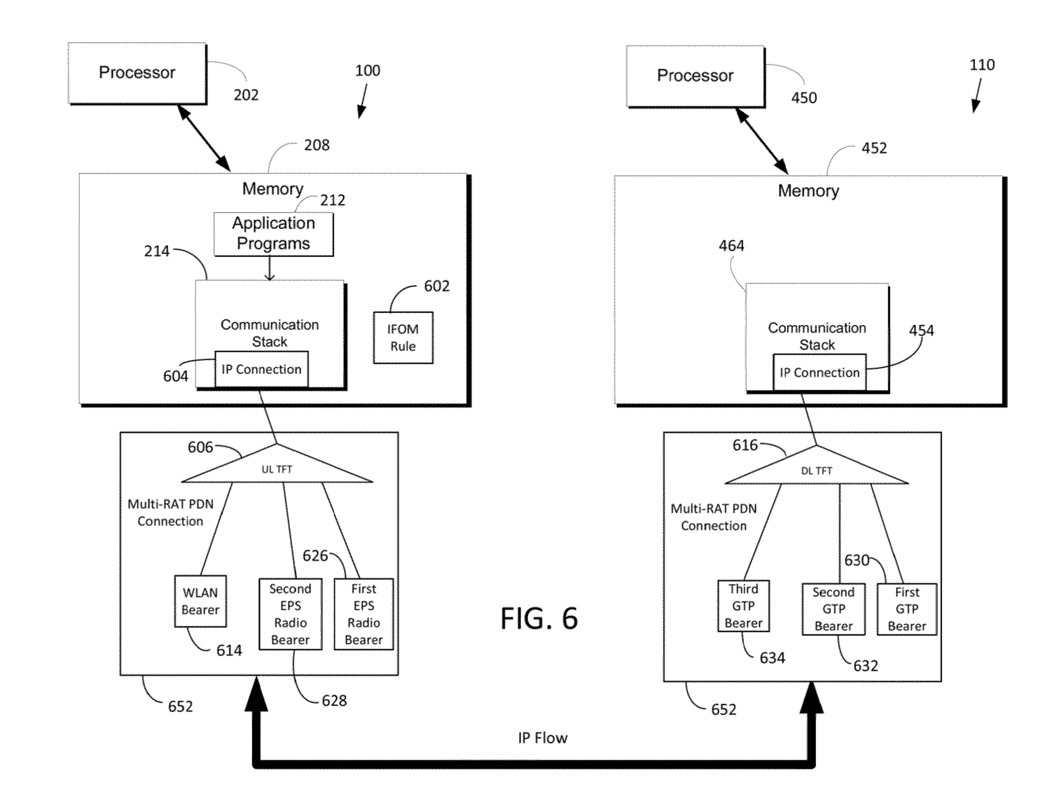

Turning to FIG. 6, the first EPS bearer 506 is a concatenation of a first EPS radio bearer 626 and a first GTP bearer 630. The second EPS bearer 508 is a concatenation of a second EPS radio bearer 628 and a second GTP bearer 632. Assume that the UE 100 is provisioned with an IFOM rule 602 that says “traffic to APN=ims destined to user datagram protocol (“UDP”) port 5060 should be transferred over 3GPP access, while traffic to APN=ims destined to TCP port 80 should be transferred over WLAN access.” The UE 100 creates the appropriate TFT filters for the individual bearers of the multi-RAT PDN connection by converting the IFOM rule 602 into one or more packet filters. Inside the UL TFT 606, the UE 100 defines a first packet filter to be: “protocol=UDP; dest. port=5060” and a second packet filter to be “protocol=TCP; dest. port=80.” The first packet filter is associated, for example, with the first EPS radio bearer 506, while the second packet filter is associated, for example, with the WLAN bearer 614. Based on these packet filters inside the UL TFT 606, the UE 100 will (once the multi-RAT PDN connection is established) route all uplink traffic to APN=ims destined to UDP port 5060 to the first EPS radio bearer 626 of the multi-RAT PDN connection 652 and all uplink traffic to APN=ims destined to TCP port 80 to the WLAN bearer 614 of the multi-RAT PDN connection 652. The UE 100 will transfer all other traffic to APN=ims on the second EPS radio bearer 628.

After creating the packet filters in the UL TFT 606, the UE 100 transmits a WLAN control protocol (“WLCP”) request message to the TWAG 114. The WLCP request message includes an APN value (APN=ims), which associates the request with an existing PDN connection, and a Type=multi-RAT, which indicates that the requested WLAN bearer should be added to an existing PDN connection (the single-RAT PDN connection 502 in this case, shown in FIG. 5). In other words, the UE 100 is informing the TWAG 114 that the TWAG 114 should select the same PGW as the one that is currently used for the existing PDN connection and that the PGW should not release the existing PDN connection. The request message further includes the DL TFTs that should be installed in the PGW 110 for the resulting multi-RAT PDN connection. Note that these TFTs may be TFTs for the new WLAN bearer and may also be TFTs for the existing EPS bearers. Every EPS bearer has a unique “bearer identity” and can thus be identified in the WLCP request message. If the TWAG 114 is not present, but an ePDG is used instead, an S2b interface is created between the ePDG and PGW 110 and Internet key exchange protocol signaling is used instead of WLCP signaling.

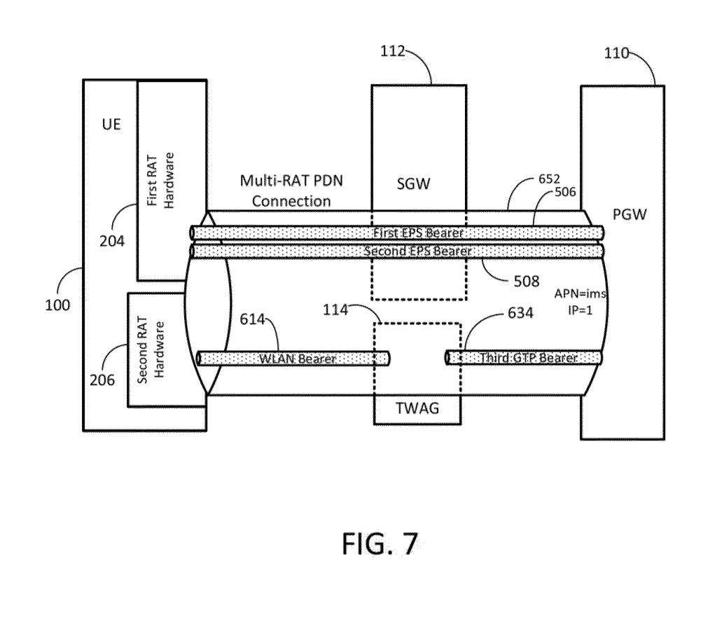

When the PGW 110 receives the GTP “Create Session Request” message, the PGW 110 amends the single-RAT PDN connection 502 with APN=ims with a new GTP bearer (a third GTP bearer 634, which terminates to the TWAG 114) and installs new packet filters in the DL TFT (e.g., a first DL packet filter and a second DL packet filter, in this case) that were provided by the UE 100. The first DL packet filter is “protocol=UDP; source. port=5060.” The second DL packet filter is “protocol=TCP; source. port=80.” Upon completion of this procedure, the multi-RAT PDN 652 (also shown in FIG. 7) connection 702 shown in FIG. 7 is established.

The procedure described above is also applicable when the existing PDN connection is established over a trusted WLAN and the UE 100 converts it to a multi-RAT PDN connection by adding an EPS bearer. In such a case, however, the UE 100 sends a non-access stratum session management request message to the mobility management entity, e.g., a PDN Connectivity Request or a Request Bearer Resource Modification that includes Type=Multi-RAT, APN=ims, and the DL TFTs.

Note that when a WLAN bearer is associated with multiple GTP or PMIPv6 bearers (also known as S2a bearers) between the TWAG 114 and the PGW 110 (e.g., as shown in FIG. 3), UL TFT filters are also installed in the TWAG 114.

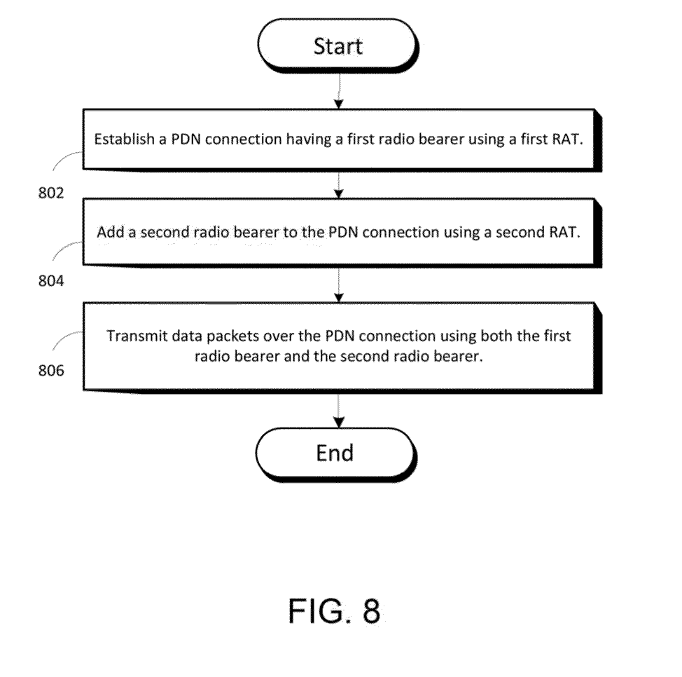

Turning to FIG. 8, a flowchart illustrates steps carried out by the UE 100 in an embodiment of the disclosure. At step 802, the UE 100 establishes a PDN connection having a first radio bearer using a first RAT. At step 804, the UE 100 adds a second radio bearer to the PDN connection using a second RAT. During the addition of the second radio bearer, the UE 100 provides one or more DL TFT filters that should be installed at the PGW 110. The one or more DL TFT filters specify the downlink traffic that should be routed within the first radio bearer and within the second radio bearer. The UE 100 also specifies that the addition is a multi-RAT bearer addition—i.e., the addition of a bearer in a PDN connection on a different RAT type. At step 806, the UE 100 transmits data packets over the PDN connection using both the first radio bearer and the second radio bearer.

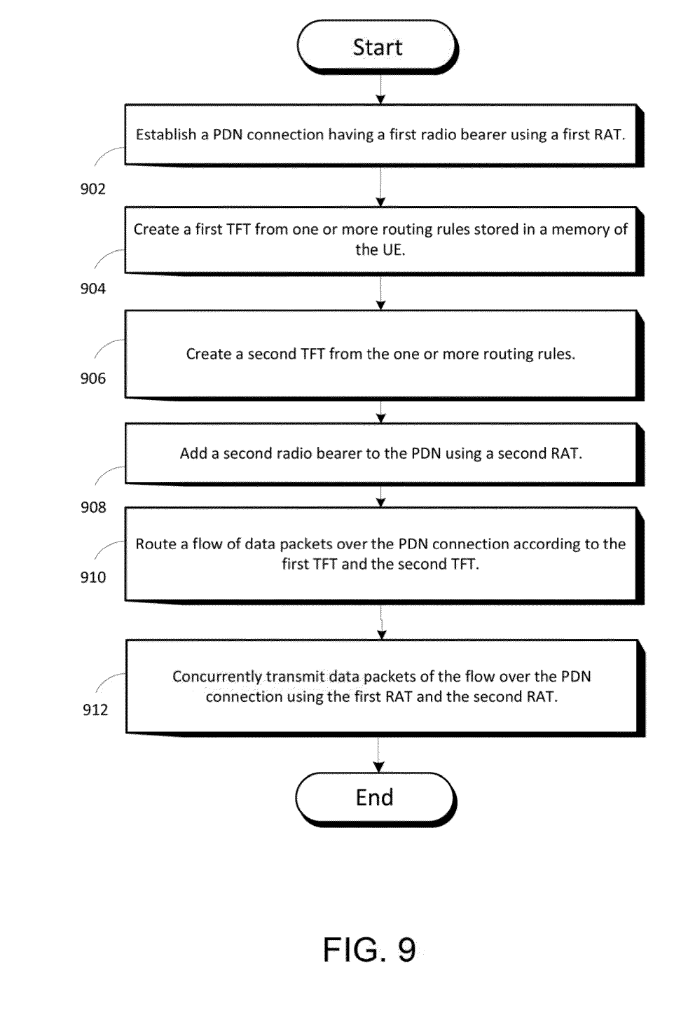

Turning to FIG. 9, a flowchart illustrates steps carried out by the UE 100 in another embodiment of the disclosure. At step 902, the UE 100 establishes a PDN connection having a first bearer using a first RAT. At step 904, the UE 100 creates a first TFT from one or more routing rules stored in a memory of the UE. At step 906, the UE 100 creates a second TFT from the one or more routing rules. At step 908, the UE 100 adds a second radio bearer to the PDN connection using a second RAT. At step 910, the UE 100 routes a flow of data packets over the PDN connection according to the first TFT and according to the second TFT. At step 912, the UE 100 concurrently transmits data packets of the flow over the first bearer and over the second bearer.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for converting a single radio-access technology (“RAT”) packet-data network (“PDN”) connection into a multi-RAT PDN connection, the method comprising:
establishing a PDN connection having a first radio bearer using a first RAT;
adding a second radio bearer to the PDN connection using a second RAT; and
transmitting data packets over the PDN connection using both the first radio bearer and the second radio bearer.

2. The method of claim 1:
wherein adding a second radio bearer comprises:
creating a first traffic-flow template (“TFT”) for the first radio bearer; and
creating a second TFT for the second radio bearer; and
wherein transmitting data packets over the PDN connection comprises:
transmitting data packets over the first radio bearer according to the first TFT; and
transmitting the data packets over the second radio bearer according to the second TFT.

3. The method of claim 2:
wherein transmitting data packets over the first radio bearer according to the first TFT comprises if the data packets are voice over Internet protocol (“IP”) packets, then transmitting the data packets over the first radio bearer; and
wherein transmitting data packets over the second radio bearer according to the second TFT comprises if the data packets carry web-browsing traffic, then transmitting the data packets over the second radio bearer.

4. The method of claim 2 wherein the first TFT includes a first set of IP filters and the second TFT includes a second set of IP filters.

5. The method of claim 1 wherein the data packets are IP packets.

6. The method of claim 1 wherein the first RAT is a cellular communication technology.

7. The method of claim 1 wherein the second RAT is a wireless local area network technology.

8. The method of claim 1 wherein the first radio bearer is an evolved packet system radio bearer.

9. The method of claim 1 wherein the second radio bearer is a wireless local area network radio bearer.

10. A method, on a user equipment (“UE”), for converting a single radio-access technology (“RAT”) packet-data network (“PDN”) connection into a multi-RAT PDN connection, the method comprising:
establishing a PDN connection having a first radio bearer using a first RAT;
creating a first traffic-flow template (“TFT”) from one or more routing rules stored in a memory of the UE;
creating a second TFT from the one or more routing rules;
adding a second radio bearer to the PDN connection using a second RAT;
routing a flow of data packets over the PDN connection according to the first TFT and according to the second TFT; and
concurrently transmitting data packets of the flow over the first radio bearer and over the second radio bearer.

11. The method of claim 10 wherein the one or more routing rules are Internet protocol (“IP”) flow mobility (“IFOM”) rules.

12. The method of claim 11 further comprising receiving the one or more IFOM rules from an access network discovery and selection function.

13. The method of claim 10 wherein the data packets are IP packets.

14. The method of claim 10 wherein the first RAT is a cellular communication technology.

15. The method of claim 10 wherein the second RAT is a wireless local area network technology.

16. The method of claim 10 wherein the first radio bearer is an evolved packet system radio bearer.

17. The method of claim 10 wherein the second radio bearer is a wireless local area network radio bearer.

18. An apparatus for converting a single radio-access technology (“RAT”) packet-data network (“PDN”) connection into a multi-RAT PDN connection, the apparatus comprising:
first RAT hardware;
second RAT hardware; and
a processor configured to:
establish a PDN connection having a first radio bearer using a first RAT;
add, using a second RAT, a second radio bearer for the PDN connection;
using the first RAT hardware, transmit data packets over the PDN connection on the first radio bearer; and
using the second RAT hardware, transmit data packets over the PDN connection on the second radio bearer.

19. The apparatus of claim 18 wherein the processor is further configured to:
create a first traffic-flow template (“TFT”) for the first radio bearer;
create a second TFT for the second radio bearer;
using the first RAT hardware, transmit data packets over the first radio bearer according to the first TFT; and
using the second RAT hardware, transmit the data packets over the second radio bearer according to the second TFT.

20. The apparatus of claim 19 wherein the first TFT includes a first set of Internet protocol filters and wherein the second TFT includes a second set of Internet protocol filters.
